(19) United States
(12) Patent Application Publication
(10) Pub. No.: US 2008/0059207 A1
(43) Pub. Date: Mar. 6, 2008

(54) SYSTEM AND METHOD FOR CONTENT FUNCTIONALITY

(75) Inventor: Petros Belimpasakis, Tampere (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/469,597

(22) Filed: Sep. 1, 2006

(51) Int. Cl. G06Q 10/00; G06Q 30/00

(52) U.S. Cl. 705/1

(57) ABSTRACT

Systems and methods applicable, for example, in content functionality. Content corresponding to a user might, for example, be received. Some or all of the content might, for instance, be provided to one or more vehicles indicated by travel information corresponding to the user. Some or all of the content might, for example, be made available at one or more passenger areas indicated by the travel information.

### FIELD OF THE INVENTION

This invention relates to systems and methods for content functionality.

### BACKGROUND INFORMATION

In recent times, there has been an increase in the use of content (e.g., digital content). For example, many users have increasingly come to prefer such over other forms of, for instance, audio and/or video. Moreover, such has come to represent an increasing percentage of many user collections of, for example, audio and/or video.

Accordingly, there may be interest in technologies that make use of such content.

### SUMMARY OF THE INVENTION

According to embodiments of the present invention, there are provided systems and methods applicable, for example, in content functionality.

In various embodiments, content corresponding to a user might be received. Some or all of the content might, in various embodiments, be provided to one or more vehicles indicated by travel information corresponding to the user.

In various embodiments, some or all of the content might be made available at one or more passenger areas indicated by the travel information.

### BRIEF DESCRIPTION OF THE DRAWINGS

FIG. 1 shows exemplary steps involved in content procurement operations according to various embodiments of the present invention.

FIG. 2 shows further exemplary steps involved in content procurement operations according to various embodiments of the present invention.

FIG. 3 shows exemplary steps involved in content presentation operations according to various embodiments of the present invention.

FIG. 4 shows further exemplary steps involved in content presentation operations according to various embodiments of the present invention.

FIG. 5 shows an exemplary computer.

FIG. 6 shows a further exemplary computer.

### DETAILED DESCRIPTION OF THE INVENTION

### General Operation

According to embodiments of the present invention, there are provided systems and methods applicable, for example, in content functionality.

In various embodiments, content (e.g., audio content, video content, and/or software) corresponding to a user might be received. The content might, in various embodiments, be uploaded by the user, be provided by one or more devices of the user, be provided by one or more content vendors, and/or be provided via podcast. In various embodiments, some or all of the content might be received subsequent to reservation information (e.g., flight reservation information) being received from the user.

Some or all of the content might, in various embodiments, be provided to one or more vehicles (e.g., one or more airplanes, buses, trains, ships, and/or automobiles) indicated by travel information corresponding to the user. In various embodiments, some or all of the content might be made available at one or more passenger areas indicated by the travel information.

Equipment (e.g., a seat-based, cabin-based, and/or vehicle-based entertainment unit) at such a passenger area might, in various embodiments, allow for use of some or all of the content.

Various aspects of the present invention will now be discussed in greater detail.

### Content Procurement Operations

According to various embodiments of the present invention, one or more servers and/or other computers might come to possess content (e.g., digital content) corresponding to a user.

Such content might, for instance, be content that the user wants to have available in one or more vehicles. Such vehicles might, for instance, include airplanes, buses, trains, ships (e.g., cruise ships), and/or automobiles (e.g., rental automobiles). The content might, for instance, include audio content (e.g., music and/or spoken word content), video content (e.g., movies and/or television shows), and/or software (e.g., single-player and/or multiplayer game software, and/or productivity software). Such functionality might be implemented in a number of ways.

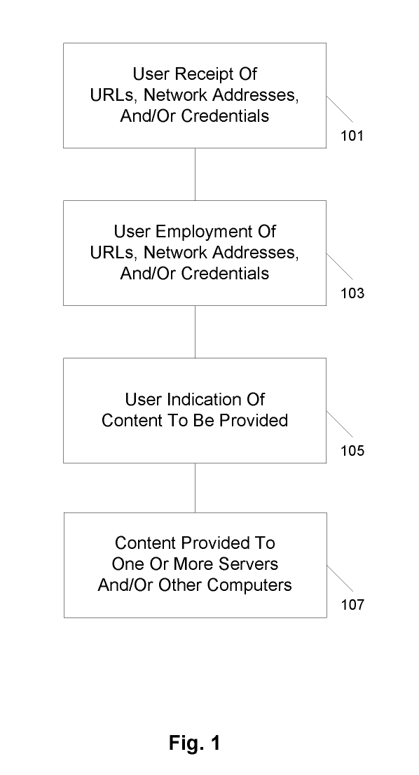

For example, one or more of the servers and/or other computers might come to posses content due to user provision. With respect to FIG. 1, describing one or more aspects of the invention, it is noted that the user might, for instance indicate (e.g., via a Graphical User Interface (GUI) and/or other interface) to one or more websites, one or more web applications, one or more web services, and/or one or more software modules content to be provided to the one or more servers and/or other computers (step 105). One or more devices of the user (e.g., one or more wireless nodes and/or other computers) might, for example, be employed in providing such indication.

The user might, for instance, be able to drag and drop content that he wished the one or more servers and/or other computers to possess, and/or might be able to browse content and/or select those content items that he wished the one or more servers and/or other computers to possess.

The websites, web applications, web services, and/or software modules might, for example, perform one or more operations to allow one or more of the servers and/or other computers to come to possess some or all of the content indicated by the user. For instance, the websites, web applications, web services, and/or software modules might receive from one or more devices of the user where the indicated content was located (e.g., one or more wireless nodes and/or other computers), and/or provide to one or more of the servers and/or other computers, some or all of the content indicated by the user (step 107).

Such receipt and/or provision might, for instance, involve communication modalities such as Bluetooth (e.g., IEEE 802.15.1 Bluetooth), IEEE 802.11b. IEEE 802.11g, IEEE 802.11n, IEEE 802.16e, Local Area Network (LAN), Wide Area Network (WAN) (e.g., the Internet), Web-based Distributed Authoring and Versioning (WebDAV), File Transfer Protocol (FTP), Apple Filing Protocol (AFP), Server Message Block (SMB), Really Simple Syndication (RSS), Real-time Transport Protocol (RTP), General Packet Radio Service (GPRS), Universal Mobile Telecommunications Service (UMTS), Global System for Mobile Communications (GSM), Simple Object Access Protocol (SOAP), Java Messaging Service (JMS), Remote Method Invocation (RMI), Remote Procedure Call (RPC), sockets, and/or pipes. It is noted that, in various embodiments, the one or more servers and/or other computers coming to possess some or all of the content indicated by the user might involve the one or more servers and/or other computers fetching such content, and/or the one or more servers and/or other computers receiving such content via upload.

The websites, web applications, web services, and/or software modules might, for instance, run at and/or remote from one or more of the servers and/or other computers, run at and/or remote from one or more devices of the user (e.g., one or more wireless nodes and/or other computers), and/or might be in communication with one or more of the servers and/or other computers and/or one or more devices of the user. Such communication might, for example, involve one or more of the communication modalities discussed above (e.g., SOAP might be employed).

The user might, for instance, employ one or more Uniform Resource Locators (URLs), network addresses, and/or credentials (e.g., one or more passwords) in accessing the websites, web applications, web services, and/or software modules (step 103). The user might receive such URLs, network addresses, and/or credentials in a number of ways (step 101). For instance, the user might receive such with and/or subsequent to the user making a travel reservation, via email, along with an electronic ticket, via printed materials (e.g., via ticket and/or itinerary materials), and/or verbally (e.g., via a customer service representative and/or via a telephonic or other voice synthesis system). It is noted that, in various embodiments, such one or more passwords might additionally be employable in later access of uploaded content.

It is noted that, in various embodiments, the one or more servers and/or other computers might be presented to the user (e.g., via a GUI and/or other interface) as one or more mounted drives (e.g., as one or more web folders). Accordingly, for instance, the user might be able to indicate content to be provided to the one or more servers and/or other computers in a manner analogous to indicating to his device content to be provided to a local drive. Accordingly, for instance, the user might employ a file management interface provided by his device.

As another example, one or more of the servers and/or other computers might come to posses content via provision by one or more devices of the user (e.g., one or more wireless nodes and/or other computers). The user might, for instance, configure (e.g., via a GUI and/or other interface) one or more folders of one or more of his devices to be accessible (e.g., by one or more of the servers and/or other computers). The user might, for example, place (e.g., via a GUI and/or other interface) one or more content items that he wished the one or more servers and/or other computers to possess in one or more such folders, and/or might select (e.g., via a GUI and/or other interface) one or more such folders already containing such content items. Such configuration of one or more folders to be accessible by one or more of the servers and/or other computers might, for instance, involve the user setting one or more permissions, URLs, network addresses, and/or credentials (e.g., passwords). One or more devices of the user (e.g., one or more wireless nodes and/or other computers) might, for example, be employed in providing such configuration, placement, and/or selection.

The one or more servers and/or other computers might, in various embodiments, come to posses information employable in accessing the one or more folders (e.g., one or more URLs, network addresses, and/or credentials). Such functionality might be implemented in a number of ways.

For example, the user might indicate such (e.g., via a GUI and/or other interface) to one or more websites, one or more web applications, one or more web services, and/or one or more software modules. As another example, such might be provided to one or more websites, one or more web applications, one or more web services, and/or one or more software modules in an automated fashion. For instance, one or more software modules running at one or more devices of the user might provide such to the one or more websites, web applications, web services, and/or software modules.

The one or more websites, web applications, web services, and/or software modules receiving such information employable in accessing the one or more folders might, for example, perform one or more operations to allow the appropriate one or more servers and/or other computers to come to possess the corresponding content. For example, the websites, web applications, web services, and/or software modules might employ the information in retrieving some or all of the content items from the folders, and/or might provide some or all of the content to the one or more servers and/or other computers. Such receipt and/or provision might, in various embodiments, involve one or more of the communication modalities discussed above (e.g., WebDAV and/or SOAP might be employed).

In various embodiments the websites, web applications, web services, and/or software modules might, perhaps in a manner analogous to that discussed above, run at and/or remote from one or more of the servers and/or other computers, run at and/or remote from one or more devices of the user, and/or might be in communication with one or more of the servers and/or other computers and/or one or more devices of the user. In various embodiments the user might, perhaps in a manner analogous to that discussed above, employ one or more URLs and/or network addresses in accessing the websites, web applications, web services, and/or software modules.

The one or more servers and/or other computers might, for example, come to possess such content in view of travel information corresponding to the user (e.g., subsequent to one or more websites, web applications, web services, and/or software modules performing travel information consultation). For instance, departure time information might be taken into account such that the one or more servers and/or other computers could come to possess the content at and/or prior to one or more departures of the user.

For example, the one or more servers and/or other computers might come to possess content corresponding to a particular departure a certain number of days (e.g., one day) before that departure. As another example, the one or more servers and/or other computers might come to posses content corresponding to a particular departure a certain number of hours (e.g., one hour) before that departure. It is noted that, in various embodiments, the one or more servers and/or other computers coming to possess content might involve the one or more servers and/or other computers fetching such content, and/or the one or more servers and/or other computers receiving such content via upload.

It is noted that, in various embodiments, in the case where the user has configured one or more folders of one or more of his devices to be accessible (e.g., as discussed above), the user might not need to perform such configuration again in order to have the one or more servers to receive content in the future (e.g., for future departures). For example, in various embodiments the user might need only to act to keep in such folders content that he wished the one or more servers and/or other computers to possess, and the one or more serves and/or other computers could come to possess the content as appropriate (e.g., periodically, and/or at and/or prior to one or more future departure times).

It is noted that, in various embodiments, the one or more servers and/or other computers coming to posses content via provision by one or more devices of the user might involve the operations of one or more media programs (e.g., one or more programs for music and/or video storage and/or use) operating at and/or remote from one or more devices of the user. For example, the websites, web applications, web services, and/or software modules might interface with such a media program in such a fashion that the one or more servers and/or other computers appeared to the media program as one or more storage locations and/or media player devices (e.g., portable audio and/or video players).

Accordingly, for example, the user might be able to indicate content items that the one or more servers and/or other computers should come to posses by acting (e.g., via a GUI and/or other interface) in a manner analogous to indicating content to be moved to such a storage location and/or media player device. Alternately or additionally, such a media program might act to synchronize with the servers and/or other computers in a manner analogous to synchronizing with such a storage location and/or media player device.

Such functionality might be implemented in a number of ways. For instance, the websites, web applications, web services, and/or software modules might act in communications between the media program and the one or more servers and/or other computers such that the one or more servers and/or other computers appeared to the media program as one or more storage locations and/or media player devices.

As yet another example, one or more of the servers and/or other computers might come to posses content via one or more podcasts. Such functionality might be implemented in a number of ways. For example, the user might indicate (e.g., via a GUI and/or other interface) to one or more websites, one or more web applications, one or more web services, and/or one or more software modules podcast content to be provided to the one or more servers and/or other computers. One or more devices of the user (e.g., one or more wireless nodes and/or other computers) might, for instance, be employed in providing such indication.

The user might, for example, indicate one or more sources of the podcast content. For instance, the user might indicate one or more URLs. As another example, the user might be offered (e.g., via a GUI and/or other interface) podcast content and be able to indicate the podcast content that he wished to be provided to the one or more servers and/or other computers.

Such offering of podcast content might, for instance, be provided by the one or more websites, one or more web applications, one or more web services, and/or one or more software modules. The one or more websites, one or more web applications, one or more web services, and/or one or more software modules might, in various embodiments, have access to one or more local and/or remote stores indicating sources (e.g., URLs) for podcast content offered to the user. Accordingly, for instance, the one or more websites, one or more web applications, one or more web services, and/or one or more software modules might act to determine one or more sources corresponding to selection by the user of offered podcast content.

The websites, web applications, web services, and/or software modules might, for example, perform one or more operations to allow one or more of the servers and/or other computers to come to possess some or all of the podcast content indicated by the user. The one or more websites, one or more web applications, one or more web services, and/or one or more software modules might, for instance, receive some or all of the indicated podcast content from one or more sources of that content, and/or provide to one or more of the servers and/or other computers some or all of that podcast content. Such receipt and/or provision might, for instance, be performed in a manner employing one or more of the communication modalities discussed above (e.g., RSS and/or SOAP might be employed).

In various embodiments, the one or more servers and/or other computers might, perhaps in a manner analogous to that discussed above, come to posses podcast content in view of travel information corresponding to the user. Accordingly, for instance, the one or more servers and/or other computers might come to possess such content at and/or prior to one or more departures of the user (e.g., one or more hours before one or more departures of the user).

In various embodiments the websites, web applications, web services, and/or software modules might, perhaps in a manner analogous to that discussed above, run at and/or remote from one or more of the servers and/or other computers, run at and/or remote from one or more devices of the user, and/or might be in communication with one or more of the servers and/or other computers and/or one or more devices of the user. In various embodiments the user might, perhaps in a manner analogous to that discussed above, employ one or more URLs and/or network addresses in accessing the websites, web applications, web services, and/or software modules.

It is further noted that, in various embodiments, the one or more servers and/or other computers coming to possess podcast content might involve the one or more servers and/or other computers fetching such podcast content, and/or the one or more servers and/or other computers receiving such podcast content via upload.

As a further example, one or more of the servers and/or other computers might come to possess content via provision by one or more content vendors (e.g., online music and/or video stores). The user might, for instance, indicate (e.g., via a GUI and/or other interface) to one or more websites, one or more web applications, one or more web services, and/or one or more software modules content from the content vendor to be provided to the one or more servers and/or other computers. One or more devices of the user (e.g., one or more wireless nodes and/or other computers) might, for example, be employed in providing such indication. As an example, the user might provide such indication via a content vendor website, a content vendor web application, and/or via content vendor software running at one or more devices of the user.

The websites, web applications, web services, and/or software modules might, for example, perform one or more operations to allow one or more of the servers and/or other computers to come to possess some or all of the content from the content vendor indicated by the user. The websites, web applications, web services, and/or software modules might, for instance, receive from one or more servers and/or other computers of the content vendor, and/or provide to one or more of the servers and/or other computers that are to come to posses the selected content, some or all of the content indicated by the user. Such receipt and/or provision might, for instance, be performed in a manner employing one or more of the communication modalities discussed above.

In various embodiments, the websites, web applications, web services, and/or software modules might, perhaps in a manner analogous to that discussed above, run at and/or remote from one or more of the servers and/or other computers that are to come to possess the selected content, run at and/or remote from one or more devices of the user (e.g., one or more wireless nodes and/or other computers), run at and/or remote from one or more servers and/or other computers of the content vendor, and/or might be in communication with one or more of the servers and/or other computers that are to come to possess the selected content, one or more devices of the user, and/or one or more servers and/or other computers of the content vendor. In various embodiments the user might, perhaps in a manner analogous to that discussed above, employ one or more URLs and/or network addresses in accessing the websites, web applications, web services, and/or software modules.

It is further noted that, in various embodiments, the one or more servers and/or other computers coming to possess content provided by a content vendor might involve the one or more servers and/or other computers that are to come to possess the content fetching such content, and/or those one or more servers and/or other computers receiving such content via upload.

As discussed above, the user might, for instance, indicate content from the content vendor that is to be provided to the one or more servers and/or other computers that are to come to possess content. In various embodiments, the user might receive (e.g., via a GUI and/or other interface) indication of content from the content vendor that is available for such provision. Such indication of available content might, for instance, be provided by one or more of the websites, web applications, web services, and/or software modules discussed above.

The indication of available content might, for example, include content items that the user had already purchased from the content vendor. As another example, the indication of available content might include content items that the user had not previously purchased from the content vendor. Such indicated content items that the user had not previously purchased might, for instance, be available for purchase and/or provision to the one or more servers and/or other computers that are to come to possess content.

The user might, for instance, be able to purchase content subject to various use restrictions. For example, the user might be able to purchase content that could only be used for one or more excursions (e.g., one or more flights, trips, cruises, rentals, and/or sessions). As another example, the user might be able to purchase content that could only be used in conjunction with one or more travel providers (e.g., content that could only be used for flights on one or more certain airlines and/or use in rental automobiles from one or more automobile rental companies). As yet another example, the user might be able to purchase content that could only be used for a certain time period (e.g., the duration of a flight or cruise). In various embodiments, fees charged to the user for content subject to such restrictions might be lower than fees charged for content not subject to such restrictions. For instance, in the case where the user purchased content that could be only used for a certain flight, he might be charged a fee that was less than that charged for a full purchase of that content.

Content subject to such restrictions might, for instance, be deleted once no longer available for use (e.g., after completion of a flight). Such restrictions might, in various embodiments, be in place of or in addition to any content restrictions typically instituted by the content vendor. Digital Rights Management (DRM) might, for instance, be employed in restrictions enforcement.

In various embodiments, in the case where the user indicates content that he has already purchased from the content vendor, the content vendor might charge a fee (e.g., a fixed fee) for provision of that content to the one or more servers and/or other computers that are to come to possess content. It is noted that, in various embodiments, no such fee might be charged. In various embodiments, one or more websites, web applications, web services, and/or software modules might receive from a content vendor one or more lists of content indicated by a user. Such receipt might, for instance, involve use of one or more of the communication modalities discussed above.

As discussed above, the one or more servers and/or other computers that are to come to possess content might, in various embodiments, come to posses content corresponding to the user in a number of ways. In various embodiments, one or more devices of one or more vehicles might come to possess some or all of this content. Such vehicles might, for instance, be airplanes, buses, trains, ships, and/or automobiles. Such devices might, for instance, include one or more entertainment systems (e.g., one or more in-flight entertainment systems), and/or one or more servers and/or other computers. It is noted that, in various embodiments, such devices might include and/or be in communication with mass storage (e.g., one or more hard disks). For example, the one or more devices of a particular vehicle might include and/or be in communication with one terabyte of storage, and/or five gigabytes of storage per passenger.

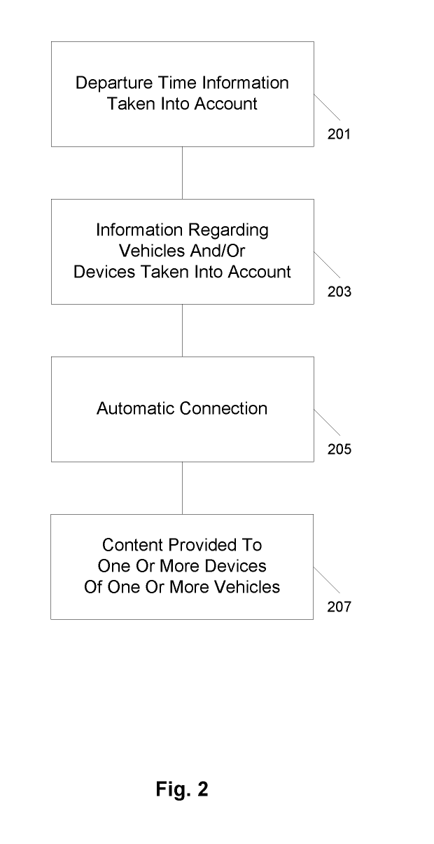

Such functionality might be implemented in a number of ways. With respect to FIG. 2, describing one or more aspects of the invention, it is noted that, for example, one or more websites, web applications, web services, and/or software modules might receive from the one or more servers and/or other computers that came to possess the content, and/or provide to one or more of the devices of the one or more vehicles, some or all of the content (step 207). Such receipt and/or provision might, for instance, be performed in a manner employing one or more of the communication modalities discussed above (e.g., IEEE 802.11g, IEEE 802.11n, UMTS, GPRS, IEEE 802.16e, WAN (e.g., the Internet), WebDAV, FTP, SMB, and/or SOAP might be employed). It is noted that, in various embodiments, the one or more devices might come to possess one or more instructions (e.g., instructions regarding content handling).

It is additionally noted that, in various embodiments, one or more devices of a vehicle might automatically connect to network infrastructure and/or to one or more networks (e.g., to the Internet, and/or to one or more IEEE 802.11g, IEEE 802.11n, UMTS, GPRS, and/or IEEE 802.16 networks) (step 205). Such automatic connection might, for instance, happen upon arrival at a travel center (e.g., an airport, train station, rental car station, and/or bus depot) and/or arrival at a passenger loading area (e.g., a gate). A network and/or network infrastructure to which connection occurs might, for instance, be associated with a travel provider (e.g., an airline), a travel center, and/or a loading area.

The websites, web applications, web services, and/or software modules might, for instance, act to select for provision to one or more devices of a particular vehicle content corresponding to one or more users associated with a particular excursion. For example, the content corresponding to one or more passengers on a particular flight might be provided to one or more devices of an aircraft to be employed in that flight.

Perhaps in a manner analogous to that discussed above, the websites, web applications, web services, and/or software modules might, in various embodiments, run at and/or remote from the one or more servers and/or other computers that came to possess the content, run at and/or remote from one or more of the devices of the one or more vehicles, and/or might be in communication with the one or more servers and/or other computers that came to possess the content and/or one or more of the devices of the one or more vehicles. It is noted that, in various embodiments, the one or more devices of the one or more vehicles coming to possess the content might involve those one or more devices fetching the content, and/or those one or more devices receiving the content via upload.

It is further noted that, in various embodiments, the one or more devices of the one or more vehicles might come to possess some or all of the content in view of travel information corresponding to the user (e.g., subsequent to one or more websites, web applications, web services, and/or software modules performing travel information consultation).

For example, departure time information might be taken into account (step 201) such that the one or more devices of the one or more vehicles came to posses the content at and/or prior to one or more departures of the user (e.g., a number of hours and/or a number of days before a departure).

As another example, information regarding the vehicles, and/or the devices of the vehicles, might be taken into account (step 203). For instance, vehicle identifiers (e.g., aircraft, train, ship, and/or automobile identifiers), and/or URLs and/or network addresses (e.g., URLs and/or network addresses of vehicle devices) might be taken into account. Accordingly, for example, the websites, web applications, web services, and/or software modules might act in view of such information so that the content corresponding to a particular user was provided to one or more devices of an appropriate vehicle via one or more network addresses of those devices. It is noted that, in various embodiments, flight or train number information might be taken into account.

It is further noted that, in various embodiments, various information (e.g., URLs and/or network addresses) discussed herein as being included in the travel information might not be included in the travel information. Accordingly, for instance, the websites, web applications, web services, and/or software modules might learn of such information (e.g., URLs and/or network addresses) by consulting one or more local and/or remote stores (e.g., stores correlating vehicle identifiers with such URLs and/or network addresses).

Functionality corresponding to deletion of content corresponding to users from the one or more servers and/or other computers that came to possess the content might, in various embodiments, be implemented. For example, content might be deleted (e.g., by action of one or more websites, web applications, web services, and/or software modules) subsequent to one or more devices of one or more vehicles coming to possess that content.

As another example, content might be retained at the one or more servers and/or other subsequent to one or more devices of one or more vehicles coming to possess the content. Such functionality might, for instance, be implemented in the case where a user corresponding to such content was to travel again within a specific period of time. Accordingly, for example, content might be so retained in the case where the user had one or more additional departures (e.g., departures associated with one or more particular travel providers, and/or with the same travel provider as one or more earlier departures) within certain time spans (e.g., within a certain number of days, hours, and/or months). Such departures might, for instance, be flight departures. Such time spans might, for instance, be set by users, system administrators, and/or travel providers. It is noted that, in various embodiments, functionality by which content could be so retained might provide for retention of content in the case of connecting departures (e.g., connecting flights). It is further noted that, in various embodiments, in the case of a departure being a connecting departure with respect to a first departure, content corresponding to the first departure might also be downloaded to the connecting departure.

As yet another example, content might retained indefinitely. Such functionality might, in various embodiments, be employed with respect to users considered to have special status (e.g., frequent travelers and/or members of travel provider clubs).

It is noted that, in various embodiments, retained content might, perhaps in a manner analogous to that discussed above, come to be possessed by appropriate devices of vehicles in the future (e.g., for future departures).

In various embodiments, users might not be consulted and/or might be consulted (e.g., via GUI and/or other interface) prior to the devices so coming to receive content in the future. Such consultation might, for instance, be via action of websites, web applications, web services, and/or software modules. It is noted that, in various embodiments, whether or not user consultation occurred before one or more appropriate devices of an appropriate vehicle came to possess content for a future departure might be dependent upon how far in the future that future departure was relative to a departure for which the content had already been provided to one or more appropriate devices of an appropriate vehicle. For example, such user consultation might not occur in the case of a connecting departure and/or a second departure within one week of a first departure, but might occur in the case of a second departure scheduled for greater than one week after a first departure.

It is noted that, according to various embodiments of the present invention, travel reservation information might be received (e.g., via GUI and/or other interface) from a user. Such receipt might, for instance, involve the action of one or more websites, web applications, web services, and/or software modules.

In various embodiments, content might be in a variety of formats. Such formats might, for instance, include MPEG-1 Audio Layer 3 (MP3), MPEG-4, DivX, Advanced Audio Coding (AAC), and/or FairPlay. It is noted that, in various embodiments, content might be required to be protected. For instance, content might be required to employ DRM and/or a particular form of DRM (e.g., FairPlay DRM).

### Content Presentation Operations

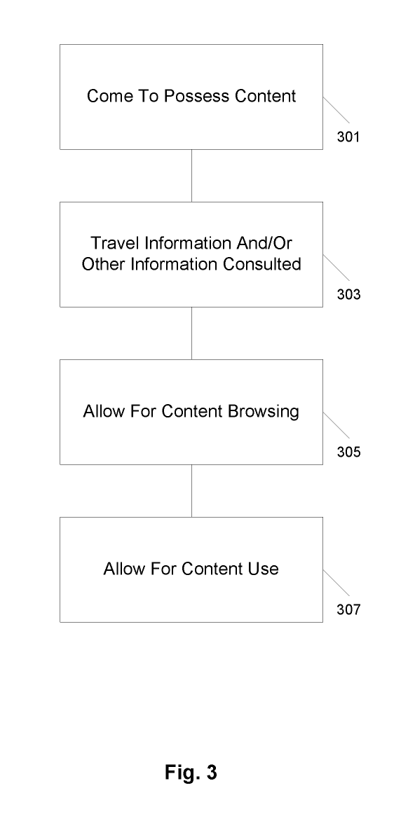

With respect to FIG. 3, describing one or more aspects of the invention, it is noted that, according to various embodiments of the present invention, one or more operations might be performed such that content, corresponding to a user, that came to be possessed by one or more devices of a vehicle (e.g., an airplane) (step 301) could be available for use. Such functionality might be implemented in a number of ways.

For instance, access to some or all of such content corresponding to a user might be made available (e.g., to that user) via one or more entertainment units associated with one or more particular passenger areas (e.g., one or more passenger areas indicated by travel information corresponding to the user). Such a passenger area might, for instance, be a seat. Such an entertainment unit might, for instance, provide video output (e.g., via one or more screens and/or video connectors), audio output (e.g., via one or more speakers and/or audio connectors), and/or one or more user input devices (e.g., one or more handheld controllers).

One or more websites, web applications, web services, and/or software modules might, for example, consult travel information corresponding to the user and/or other information to learn of one or more passenger areas corresponding to the user (step 303).

As another example, the websites, web applications, web services, and/or software modules might, perhaps via an entertainment unit at a passenger area determined to correspond to that user, indicate to the user the availability of the content, allow for browsing of the content (step 305), allow for selection of the content, and/or allow for use of the content (e.g., content listening and/or viewing) (step 307). The websites, web applications, web services, and/or software modules might, for example, run at and/or remote from the one or more devices of the vehicle. Such functionality might, for instance, involve the use of a GUI and/or other interface. The GUI and/or other interface might, for instance, be presented via the entertainment unit at the passenger area.

Moreover, such functionality might, for example, involve the use of one or more of the communication modalities discussed above (e.g., SOAP, RTP, one or more LANs, and/or IEEE 802.11g might be employed). Such modalities might be employed, for instance, in the case where the entertainment units were implemented as media players and/or computers. As another example, such entertainment units might act as peripheral devices to the one or more devices of the vehicle. For instance, the one or more devices of the vehicle might view such entertainment units as connected display devices (e.g., monitors), audio output devices (e.g., speakers and/or headphones), and/or user input devices (e.g., keyboards and/or keypads).

In various embodiments, the user might need to provide one or more passwords. For instance, one or passwords might be required in order for the user to receive indication of the availability of the content, to browse the content, and/or to use the content. Such passwords might, for example, be provided via the GUI and/or other interface. In various embodiments, such passwords might be one or more of the passwords discussed above with respect to content procurement operations.

Content corresponding to the user might, for example, be only available to that user and/or at one or more passenger areas corresponding to that user (e.g., as indicted by travel information and/or other information). As another example, such content might be available to other users and/or at other areas. For instance, in various embodiments such content might be available to another user, and/or a passenger area of that other user, in the case where that other user was a family member and/or traveling companion of the user to which the content corresponded. It is noted that, in various embodiments, one or more permissions might be set with respect to the content (e.g., due to action by the websites, web applications, web services, and/or software modules). Such permissions might, for instance, act to specify the passenger areas and/or entertainment units able to access certain content.

Functionality corresponding to deletion of content corresponding to the user from one or more devices of a vehicle might, in various embodiments, be implemented. For instance, such content might be deleted (e.g., by action of the websites, web applications, web services, and/or software modules) with termination of an excursion (e.g., a flight, trip, cruise, rental, and/or session). As an example, deletion might occur with a vehicle landing, vehicle docking, vehicle parking, and/or with user disembarkment.

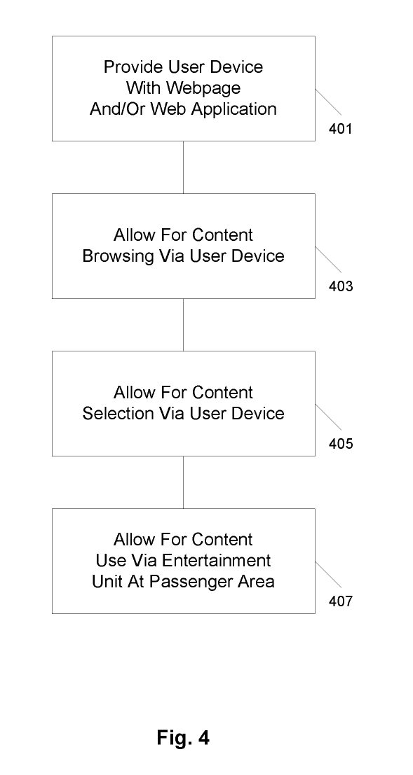

With respect to FIG. 4, describing one or more aspects of the invention, it is noted that, in various embodiments, the websites, web applications, web services, and/or software modules might, perhaps via a device of the user (e.g., a wireless node and/or other computer), indicate to the user the availability of the content corresponding to the user, allow for browsing of the content (step 403), and/or allow for selection of the content (step 405), but allow for use of the content via an entertainment unit at a passenger area determined to correspond to that user (step 407). Such functionality might, for instance, be employed in the case where the entertainment unit provided audio output, but did not provide any video output and/or did not provide any user input devices. Accordingly, for example, the user device might be employed by the user in browsing and/or selecting audio content, and the entertainment unit might be employed in listening to that content (e.g., via headphones connected to an audio connector of the entertainment unit).

Such functionality might, in various embodiments, involve the use of one or more of the communication modalities discussed above. For instance, SOAP, one or more LANs, and/or IEEE 802.11g might be employed. The user device might for instance, operate in a mode where WiFi connectivity (e.g., IEEE 802.11g connectivity) was enabled but cellular connectivity (e.g., UMTS capability) was not. Such a mode might, for example, be referred to as an “airplane mode”.

In various embodiments, the websites, web applications, web services, and/or software modules might operate such that the user device is provided with a webpage and/or web application for receiving indication of availability of the content corresponding to the user, browsing of the content, and/or selection of the content (e.g., as discussed above), the webpage and/or web application perhaps being accessed by the user via IEEE 802.11b, IEEE 802.11g, and/or IEEE 802.11n (step 401).

It is further noted that, in various embodiments, the user device might be additionally employable in content use. Accordingly, for instance, the user device might be employed by the user in browsing content, in selecting content, and/or in using content (e.g., via audio and/or video capabilities of the user device). Such content might be provided to the node for use by the user in a number of ways. For example, streaming and/or one or more of the content modalities discussed above might be employed. Accordingly, for instance, 802.11b, 802.11g, 802.11n, and/or RTP might be employed. It is noted that, in various embodiments, such functionality might, for instance, be seen as providing benefits such as the user device not needing to have sufficient storage for holding the content to be used.

It is additionally noted that, in various embodiments, user devices might be given, lent, sold, and/or rented to users (e.g., in conjunction with one or more excursions such as, for instance, flights, trips, cruises, rentals, and/or sessions). Such might, for instance, occur in the case where a vehicle lacked entertainment units with audio and/or video capabilities, and/or where one or more users did not already possess appropriate user devices. It is further noted that, in carious embodiments, a user device might be an Internet tablet.

In various embodiments, one or more people might be able to provide content to one or more other people. Such content provision might, for example, be with respect to one or more vehicles, be subject to one or more restrictions (e.g., via DRM), be subject to one or more license fees (e.g., additional license fees), and/or be subject to one or more content delivery fees. Such content might, for instance, be selectable (e.g., a GUI and/or other interface discussed herein) by the one or more people to whom it is provided (e.g., at one or more specified vehicles).

It is noted that, in various embodiments, there may be one or more license servers and/or service providers from which one or more licenses to content (e.g., delivered personal content) can be requested, and/or to which one or more fees (e.g., license fees) can be paid.

### Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

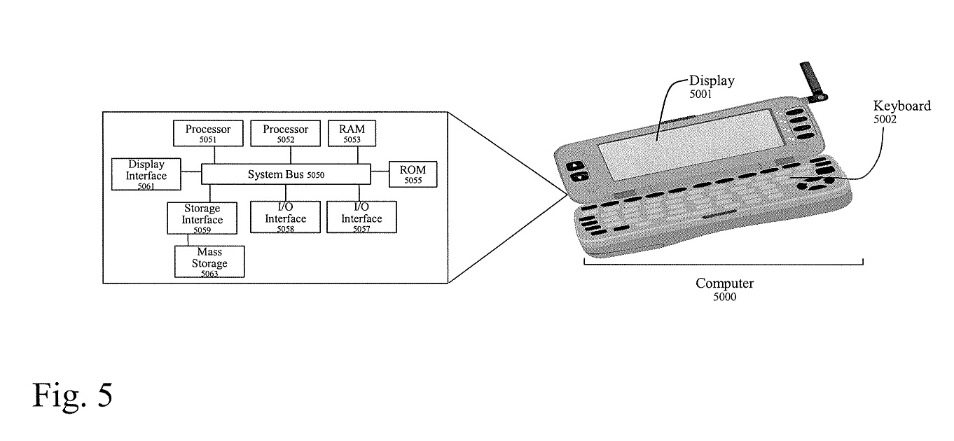

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 5 is an exemplary computer employable in various embodiments of the present invention. Exemplary computer 5000 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 5063 may be a hard drive, optical drive, a memory chip, or the like. Processors 5051 and 5052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

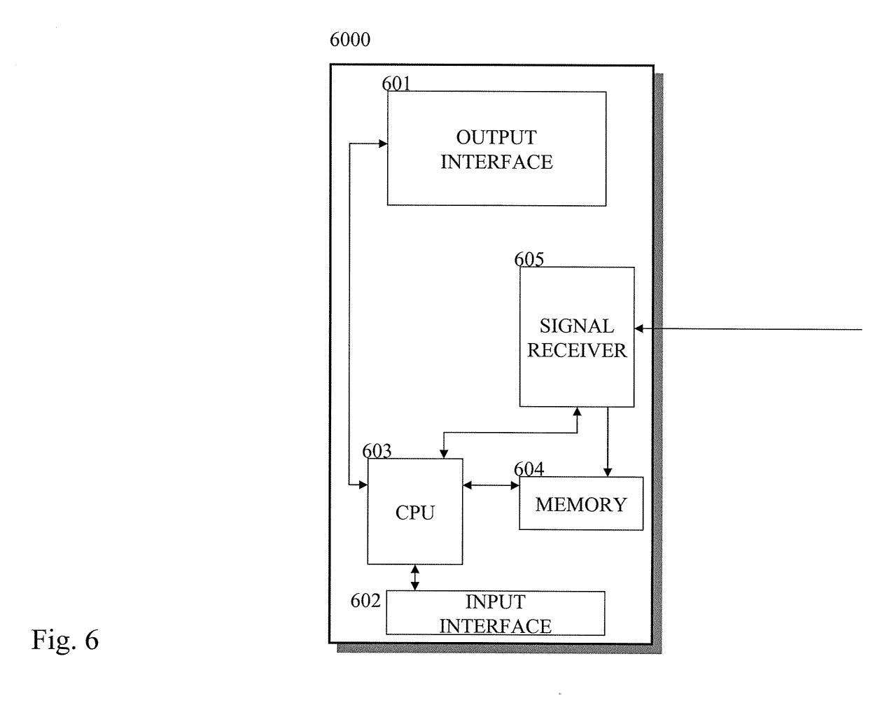

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604, and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
receiving content corresponding to a user;
consulting travel information corresponding to the user; and
providing, in accordance with the travel information, some or all of the content to one or more devices of a vehicle.

2. The method of claim 1, wherein some or all of the content is provided by the user.

3. The method of claim 1, wherein some or all of the content is provided by one or more devices of the user.

4. The method of claim 1, wherein some or all of the content is provided by one or more content vendors.

5. The method of claim 1, wherein some or all of the content is provided via one or more podcasts.

6. The method of claim 1, wherein the vehicle is an airplane.

7. The method of claim 1, wherein some or all of the content is use restricted.

8. The method of claim 1, further comprising receiving reservation information from the user.

9. A method, comprising:
receiving, at one or more devices of a vehicle, content corresponding to a user;
consulting travel information corresponding to the user; and
providing access to some or all of the content via one or more entertainment units associated with one or more passenger areas indicated by the travel information.

10. The method of claim 9, wherein some or all of the content is provided by the user.

11. The method of claim 9, wherein some or all of the content is provided by one or more devices of the user.

12. The method of claim 9, wherein some or all of the content is provided by one or more content vendors.

13. The method of claim 9, wherein some or all of the content is provided via one or more podcasts.

14. The method of claim 9, wherein the vehicle is an airplane.

15. The method of claim 9, wherein some or all of the content is use restricted.

16. The method of claim 9, further comprising deleting some or all of the content corresponding to the user.

17. An apparatus, comprising:
a memory having program code stored therein; and
a processor disposed in communication with the memory for carrying out instructions in accordance with the stored program code;
wherein the program code, when executed by the processor, causes the processor to perform:
receiving content corresponding to a user;
consulting travel information corresponding to the user; and
providing, in accordance with the travel information, some or all of the content to one or more devices of a vehicle.

18. The apparatus of claim 17, wherein some or all of the content is provided by the user.

19. The apparatus of claim 17, wherein some or all of the content is provided by one or more devices of the user.

20. The apparatus of claim 17, wherein some or all of the content is provided by one or more content vendors.

21. The apparatus of claim 17, wherein some or all of the content is provided via one or more podcasts.

22. The apparatus of claim 17, wherein the vehicle is an airplane.

23. The apparatus of claim 17, wherein some or all of the content is use restricted.

24. The apparatus of claim 17, wherein the processor further performs receiving reservation information from the user.

25. An apparatus, comprising:
a memory having program code stored therein; and
a processor disposed in communication with the memory for carrying out instructions in accordance with the stored program code;
wherein the program code, when executed by the processor, causes the processor to perform:
receiving, at the apparatus, content corresponding to a user;
consulting travel information corresponding to the user; and
providing access to some or all of the content via one or more entertainment units associated with one or more passenger areas indicated by the travel information, wherein the apparatus is associated with a vehicle.

26. The apparatus of claim 25, wherein some or all of the content is provided by the user.

27. The apparatus of claim 25, wherein some or all of the content is provided by one or more devices of the user.

28. The apparatus of claim 25, wherein some or all of the content is provided by one or more content vendors.

29. The apparatus of claim 25, wherein some or all of the content is provided via one or more podcasts.

30. The apparatus of claim 25, wherein the vehicle is an airplane.

31. The apparatus of claim 25, wherein some or all of the content is use restricted.

32. The apparatus of claim 25, wherein the processor further performs deleting some or all of the content corresponding to the user.

33. An article of manufacture comprising a computer readable medium containing program code that when executed causes an apparatus to perform:
receiving content corresponding to a user;
consulting travel information corresponding to the user; and
providing, in accordance with the travel information, some or all of the content to one or more devices of a vehicle.

34. An article of manufacture comprising a computer readable medium containing program code that when executed causes an apparatus to perform:
receiving, at the apparatus, content corresponding to a user;
consulting travel information corresponding to the user; and
providing access to some or all of the content via one or more entertainment units associated with one or more passenger areas indicated by the travel information,
wherein the apparatus is associated with a vehicle.
